(19) United States
(12) Patent Application Publication
(10) Pub. No.: US 2002/0023352 A1
(43) Pub. Date: Feb. 28, 2002

(54) Razor cartridge with enhanced access to wrinkled and curved skin surfaces

(76) Inventor: Samson Mil'shtein, Chelmsford, MA (US)

Correspondence Address: Samson Mil'shtein, 6 Warwick Dr., Chelmsford, MA, 01824, US

(21) Appl. No.: 09/783,453

(22) Filed: Aug. 13, 2001

Related U.S. Application Data
(60) Provisional application No. 60/183,424, filed on Feb. 18, 2000.

(51) Int. Cl. B26B 21/00

(52) U.S. Cl. 30/50; 30/526

(57) ABSTRACT

A short double and triple blade holder is invented to allow better access, high maneuverability and therefore closer shaving of skin with complex convex and concave features. Tests of a new razor demonstrated very close shaving even when the skin surface is puckered significantly folded and wrinkled The new razors can be used as stand alone or as additional (satellite) instrument to “Sensor” and/or “Mach 3” shavers.

### BACKGROUND OF INVENTION

The surface of every human face or body presents a unique combination of convex and concave segments intersecting with each other and covered by all imaginable shapes of wrinkles. For the sake of a clear description, let us focus on shaving a human face. Shaving a man's face depends on many parameters of a shaving instrument (blade), such as range of pivoting of a blade or set of blades, angle of original installation of a blade (or blades), and flexibility for bending. In addition, the use of one or two blades, or even three in a cartridge changes the way facial hair is handled during shaving.

The most advanced shaving blades are produced by Gillette Co., which offers two and three blades in a cartridge. Over 170 patents filed by Gillette Co describe the design, assembly, manufacturing procedures, etc. To name just few: the U.S. Pat. Nos. 4,026,016, 4,170,821, 4,443,940, D298,068 and others describe the aforementioned double-blade products. “Excel” allows a close shave due to the fact that one of the blade bends hairs in the “right” direction while the second blade then cuts them. “Mach 3” allows even closer shaving due to specially positioned three blades. On a straight surface, “Mach 3” performs better than “Excel.” However, despite Gillette's ad's limited access of both “Sensor” and “Mach 3” to folded and wrinkled skin reduces the closeness of shaving makes the number of shaving strokes significantly large, and most important, requires “real art” in shaving certain areas and corners. However none of the above patents presents a product similar to a cartridge described in current invention.

Yet, the closeness of any shave depends on accessibility of a given segment of the skin to a shaving instrument. Both shaving cartridges, namely “Excel” and “Mach 3” (as well as “Schick” and others are limited in their closeness of shaving due to their width and length of the blade's cartridges. One faces substantial difficulties of shaving under the nose or close to lip corners (just to name a few areas) due to limited access of these areas by “bulky” blade cartridges. Clearly, the best access to any complicated surface of skin under shaving would be provided by point-like razor. However, it is easy to foresee how many cuts and scratches would be produced by such a dangerous shaving instrument.

### DESCRIPTION OF THE INVENTION

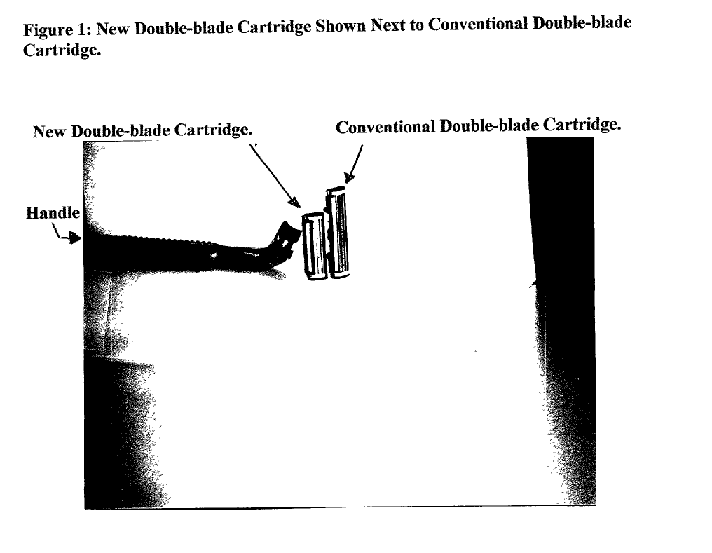

In order to improve state-of-the-art close shaving razors we offer a new invention, where based on a two or three blade combination, the length of the cartridge is reduced from 39 mm to 28 mm, or about 28.2%. FIG. 1 shows a conventional double-blade cartridge and a prototype for comparison. One can see from the figure that the shorter cartridge allows for better access and maneuverability for close shaving. In fact, the length of the cartridge can be decreased even more. However, to make the razor compatible with Gillette's “Sensor” handle it is proposed to keep the original design of Gillette's cartridge about the same, changing only the length of it.

The summary of the patent is presented by the following claims:

1. In order to improve closeness of shaving by a double (or triple) blade Gillette razor, it is proposed to make the cartridge 28 mm long instead of the 39 mm length of the existing product.

2. According to claim 1, the cartridge should be made compatible to the handle of Gillette's razor named “Sensor.” That requires to keep latches for pivoting of the cartridge unchanged.

3. According to claims 1 and 2, the proposed cartridge for dual blades are made shorter in such a way that metal strips used to keep the blades are immediately adjacent to the lathes. (see FIG. 1)

4. According to claim 1, the “Mach 3” cartridge for the triple blades could be made 28 mm long. Unlike in the “Sensor” cartridge, the shortening of a triple blade cartridge will require a modification, i.e. a decrease of the length of the pivoting base of the razor

5. According to claims 1 and 4, the “Mach 3” cartridge could be made as short as 12 mm, which will improve the accessibility of complicated skin surfaces for close shaving. That will require a modification, i.e. a decrease of the length of the pivoting base of the razor.
